(19) United States
(12) Patent Application Publication
(10) Pub. No.: US 2014/0292679 A1
(43) Pub. Date: Oct. 2, 2014

(54) ELECTRONIC DEVICE, APPLICATION-EXECUTING DEVICE AND METHOD FOR CONTROLLING THE ELECTRONIC DEVICE

(71) Applicant: Japan Display Inc., Minato-ku (JP)

(72) Inventors: Yoshitoshi KIDA, Tokyo (JP); Jouji YAMADA, Tokyo (JP); Hirofumi NAKAGAWA, Tokyo (JP); Michio YAMAMOTO, Tokyo (JP); Kohei AZUMI, Tokyo (JP); Makoto HAYASHI, Tokyo (JP); Hiroshi MIZUHASHI, Tokyo (JP); Kozo IKENO, Tokyo (JP)

(73) Assignee: Japan Display Inc., Minato-ku (JP)

(21) Appl. No.: 14/184,023

(22) Filed: Feb. 19, 2014

(30) Foreign Application Priority Data
Mar. 29, 2013 (JP) 2013-073871

(51) Int. Cl. G06F 3/041

(52) U.S. Cl. CPC G06F 3/041
USPC 345/173

(57) ABSTRACT

The electronic device comprises a sensor-integrated display panel, a data transfer device, and an application execution device. The sensor-integrated display panel includes an operation surface for giving an operation input to a sensor and a display surface of an image. The data transfer device inputs a display signal and a driving signal for a sensor to the sensor-integrated display panel and receives a sensor signal from the sensor. And the application execution device time-divides display data which becomes a source of the display signal, transmits the display data and timing information to the data transfer device, the timing information indicating a period for inputting the driving signal to the sensor-integrated display panel in a blanking period of the time-divided display data.

### CROSS-REFERENCE TO RELATED APPLICATIONS

This application is based upon and claims the benefit of priority from Japanese Patent Application No. 2013-073871, filed Mar. 29, 2013, the entire contents of which are incorporated herein by reference.

### FIELD

Embodiments described herein relate generally to an electronic device, an application-executing device and a method for controlling the electronic device.

### BACKGROUND

Mobile phones, tablet computers, personal digital assistants (PDA), small-sized portable personal computers and the like have become popularized. These electronic devices have an operation input panel which also functions as a display panel.

The operation input panel detects a touch position where a user has touched a display surface by a change of capacitance, for example. A detection signal is input to a touch signal processing integrated circuit (IC) designed exclusively for the operation input panel. The touch signal processing IC processes the detection signal using a computational algorithm prepared in advance, converts the position touched by the user into coordinate data, and outputs the data.

In accordance with advance in manufacturing technology, the resolution and size of the display has been increased. Accordingly, because of the increase in the resolution and size, the operation input panel is required to detect a position with high accuracy. The operation input panel is also required to process data with respect to an operation input at high speed depending on applications. Further, a device capable of easily changing the applications is desired.

### BRIEF DESCRIPTION OF THE DRAWINGS

FIG. 1 is a block diagram of an electronic device according to an embodiment;

FIG. 2A is a sectional view illustrating a sensor-integrated display device including a display surface or display panel and an operation surface or operation input panel integrally;

FIG. 2B is an illustration showing an example of a driving signal and a detection signal of a capacitive sensor;

FIG. 3 is a perspective view illustrating sensor components of the operation input panel and a method for driving the sensor components;

FIG. 4 is a block diagram showing an example of a structure of a data transfer device shown in FIG. 1, and some of functions that are realized by various applications in an application execution device shown in FIG. 1;

FIG. 5A is a chart showing an example of output timing between a display signal and a driving signal for a sensor drive electrode which are output from a driver shown in FIGS. 1 and 4;

FIG. 5B is a schematic view illustrating an output of the driving signal for the sensor drive electrode and a driving state of a common electrode;

FIG. 6 is a block diagram showing another embodiment;

FIG. 7 is a 3D graph showing an example of raw data (detection data) on a sensor signal when no input operation is performed; and

FIG. 8 is a 3D graph showing an example of raw data (detection data) on the sensor signal when an input operation is performed.

### DETAILED DESCRIPTION

Various embodiments will be described hereinafter with reference to the accompanying drawings.

One of embodiments described herein aim to provide an electronic device and an application-executing device which control display timing and detection timing adaptively, and a method for controlling the electronic device.

In general, according to one embodiment, the electronic device comprises a sensor-integrated display panel, a data transfer device, and an application execution device.

The sensor-integrated display panel includes an operation surface for giving an operation input to a sensor and a display surface of an image integrally. The data transfer device is configured to input a display signal and a driving signal for the sensor to the sensor-integrated display panel and to receive a sensor signal from the sensor.

And the application execution device is configured to time-divide display data which is a source of the display signal, to transmit the display data and timing information to the data transfer device, the timing information indicating a period for inputting the driving signal to the sensor-integrated display panel in a blanking period of the time-divided display data.

Embodiments will be further described hereinafter with reference to the accompanying drawings.

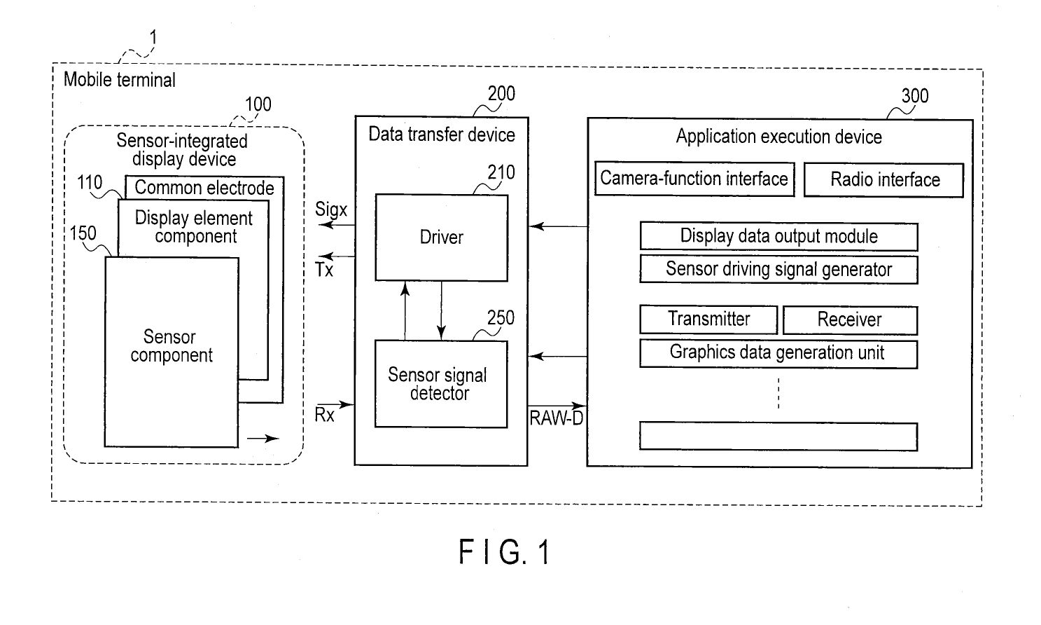

FIG. 1 shows a mobile terminal (electronic device) 1 to which one of the embodiments is applied. The mobile terminal 1 includes a sensor-integrated display device 100. The device 100 comprises a display surface (or display panel) for an image and an operation surface (or operation input panel) for giving an operation input to a sensor integrally, and includes a display element component 110 and a sensor component 150 for that purpose.

The sensor-integrated display device 100 is supplied with a display signal (or a pixel signal) from a driver 210, which will be described later. When the device 100 is supplied with a gate signal from the driver 210, a pixel signal is input to a pixel of the display element component 110. A voltage between a pixel electrode and a common electrode is determined base on the pixel signal. This voltage displaces liquid crystal molecules between the electrodes to achieve brightness corresponding to the displacement of the liquid crystal molecules.

The sensor-integrated display device 100 is not limited to this name and may be called an input sensor-integrated display unit, a user interface or the like.

For the display element component 110, a liquid crystal display panel or display panel of light-emitting elements such as LEDs or organic electroluminescent elements may be adopted. The display element component 110 can be simply called a display. The sensor component 150 is of the capacitive type. The sensor component 150 can be called a panel for detecting a touch input, a gesture and the like.

The sensor-integrated display device 100 is connected to an application execution device (application processor) 300 via a data transfer device 200.

The application execution device 300 is, for example, a semiconductor integrated circuit (LSI), which is incorporated into an electronic device, such as a mobile phone. The application execution device 300 has the function of performing a plurality of types of function processing, such as Web browsing and multimedia processing, in a complex way, using software such as an OS. The application execution device 300 as such performs high-speed operation and can be configured as a dual-core or a quad-core device. Preferably, the operating speed should be, for example, at least 500 MHz, more preferably, 1 GHz.

The data transfer device 200 includes a driver 210 and a sensor signal detector 250. Basically, the driver 210 inputs to the display element component 110 graphics data (display data) that is transferred from the application execution device 300. The sensor signal detector 250 detects a sensor signal output from the sensor component 150.

The driver 210 and the sensor signal detector 250 are synchronized with each other, and this synchronization is controlled by the application execution device 300.

The driver 210 supplies display signal Sigx (a graphics data signal subjected to digital-to-analog conversion) to the display element component 110 on the basis of an application. In response to a timing signal from the sensor signal detector 250, the driver 210 outputs driving signal Tx for scanning the sensor component 150. In synchronization with driving signal Tx, sensor signal Rx is read from the sensor component 150, and input to the sensor signal detector 250.

The sensor signal detector 250 detects the sensor signal, eliminates noise therefrom, and inputs the noise-eliminated signal to the application execution device 300 as raw read image data (which may be called three-dimensional image data).

That is, the data transfer device 200 inputs display signal Sigx and driving signal Tx for the sensor to the sensor-integrated display device 100, and receives sensor signal Rx output from the sensor.

When the sensor component 150 is of a capacitive type, the image data is not two-dimensional data simply representing a coordinate but may have a plurality of bits (for example, three to seven bits) which vary according to the capacitance. Thus, the image data can be called three-dimensional data including a physical quantity and a coordinate. Since the capacitance varies according to the distance between a target (for example, a user's finger) and a touchpanel, the variation can be captured as a change in physical quantity.

Below is the reason for the sensor signal detector 250 of the data transfer device 200 to directly provide image data to the application execution device 300, as described above.

The application execution device 300 is able to perform its high-speed arithmetic function to use the image data for various purposes.

New different kinds of applications are applied to the application execution device 300 according to the user's various desires. According to the substance of data processing, the new applications may require a change or a switch of processing method, reading (or detection) timing, reading (or detection) format, reading (or detection) area, and/or reading (or detection) density of image data.

In such a case, if only the coordinate data is received as in the conventional devices, the amount of acquired information is restricted. However, if the raw three-dimensional image data is analyzed as in the device of the present embodiment, for example, distance information as well as coordinate position information can be acquired.

It is desired that the data transfer device 200 be able to easily follow various operations under the control of applications in order to obtain expandability of various functions by the applications. Thus, the data transfer device 200 has a structure of being able to switch a reading timing, a reading area, a reading density or the like of the sensor signal arbitrarily under the control of applications, as simple function as possible. This point will be described later.

The application execution device 300 may include a transmitter, a receiver, a graphics data generation unit, a radio interface, a camera-function interface and the like.

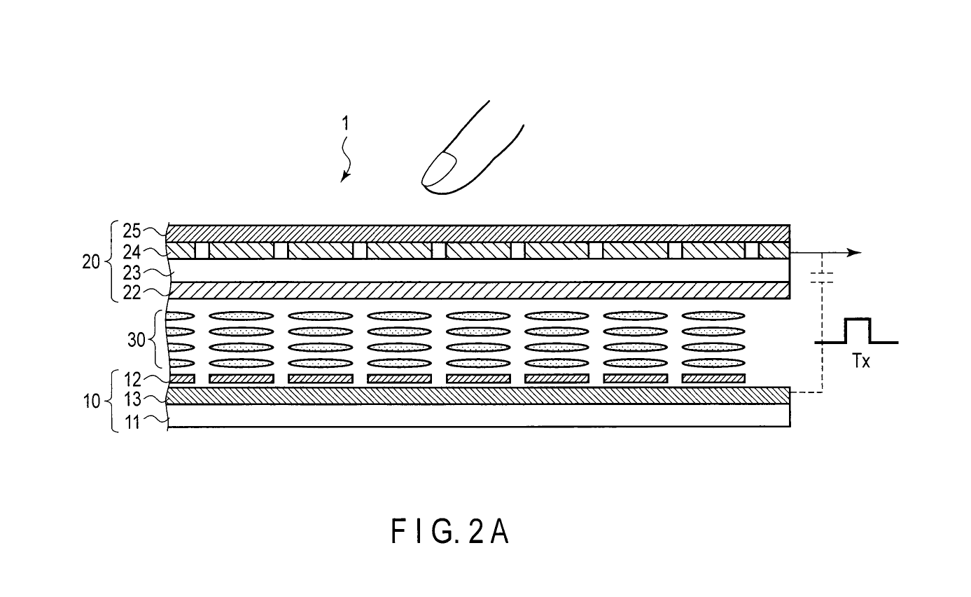

FIG. 2A is a sectional view of a basic structure of the sensor-integrated display device 100 in which the display element component 110 and the sensor component 150 are formed integrally, namely, a display device which includes the display panel and the operation input panel integrally.

An array substrate 10 is constituted by a common electrode 13 formed on a thin-film transistor (TFT) substrate 11 and a pixel electrode 12 formed above the common electrode 13 with an insulating layer interposed therebetween. A counter-substrate 20 is arranged opposite to and parallel to the array substrate 10 with a liquid crystal layer 30 interposed therebetween. In the counter-substrate 20, a color filter 22, a glass substrate 23, a sensor detection electrode 24 and a polarizer 25 are formed in order from the liquid crystal layer side.

The common electrode 13 serves as a drive electrode for a sensor (or a common drive electrode for a sensor) as well as a common drive electrode for display.

FIG. 2B is an illustration showing an example of the driving signal and the detection signal of the capacitive sensor. The capacitive sensor comprises a pair of electrodes (the common electrode 13 and the sensor detection electrode 24) which are opposed to each other with a dielectric interposed therebetween, and forms a first capacitive element.

The first capacitive element is connected to an alternating-current signal source at one end and connected to the sensor signal detector 250 shown in FIG. 1 at the other end. When an alternating-current rectangular wave (driving signal Tx) of a predetermined frequency (for example, several kilohertz to several hundreds of kilohertz or so) is applied to the common electrode 13 (i.e., at one end of the capacitive element) from the alternating-current signal source, an output waveform (sensor detected value Rx) as shown in FIG. 2B appears in the sensor detection electrode 24 (i.e., at the other end of the first capacitive element).

In a state where a finger does not touch a touchpanel, in accordance with charging and discharging of the first capacitive element, a current corresponding to the capacitance of the first capacitive element flows. A potential waveform on the other end of the first capacitive element at this time looks like waveform VO shown in FIG. 2B, for example, and this is detected by the sensor signal detector 250.

On the other hand, in a state where the finger touches the touchpanel, a second capacitive element formed by the finger is added in series with the first capacitive element. In this state, in accordance with charging and discharging of the first capacitive element and the second capacitive element, currents flow through the first capacitive element and the second capacitive element, respectively. The potential waveform on the other end of the first capacitive element at this time looks like waveform V1 shown in FIG. 2B, for example, and this is detected by the sensor signal detector 250. Here, the potential at the other end of the first capacitive element is the partial-voltage potential which is defined by the values of currents that flow through the first capacitive element and the second capacitive element. Thus, waveform V1 takes on a smaller value than waveform VO in a non-contact state. Accordingly, by comparing sensor detected value Rx with threshold value Vth, it becomes possible to determine whether the finger is touching the touchpanel.

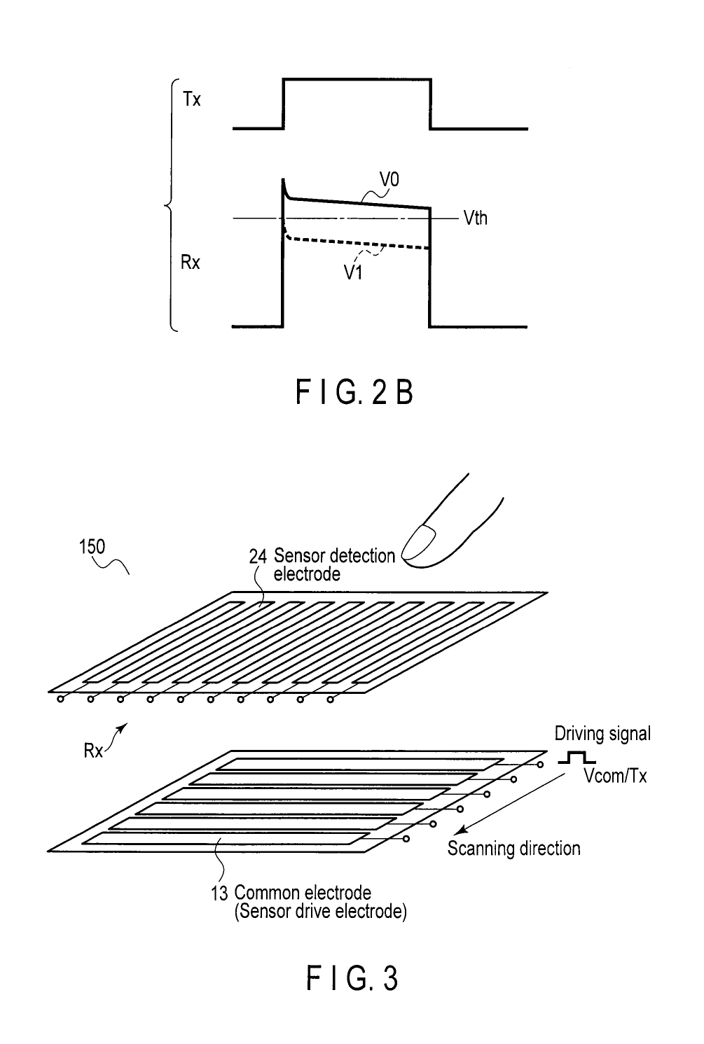

FIG. 3 is a perspective view illustrating the sensor component of the operation input panel and a method for driving the sensor component, and showing the relationship in arrangement between the sensor detection electrode 24 and the common electrode 13. The arrangement shown in FIG. 3 is an example and the operation input panel is not limited to this type.

In this example, the common electrode 13 is divided into a plurality of stripe-shaped electrode patterns extending in a second direction Y (a direction orthogonal to the scanning direction). When an image signal is written, for the electrode patterns, common voltage Vcom is sequentially applied (supplied) by the driver 210, and line-sequential scanning drive is performed in a time-divided manner. Further, when the sensor is driven, the driver 210 sequentially applies sensor driving signals Tx to each of the electrode patterns (or electrode pattern groups each formed by grouping a plurality of electrode patterns). In the present embodiment, sensor driving signals Tx which are sequentially applied to the electrode patterns (or electrode pattern groups each formed by grouping a plurality of electrode patterns) are referred to as sensor driving signals Tx1 to Txn. The subscript n for Tx represents the number of electrode patterns when sensor driving signals Tx are sequentially applied to the electrode patterns or represents the number of electrode pattern groups when sensor driving signals Tx are sequentially applied to the electrode pattern groups each formed by grouping a plurality of electrode patterns.

On the other hand, the sensor detection electrode 24 is constituted by a plurality of (m) stripe-shaped electrode patterns 1 to m extending in a direction orthogonal to the direction in which the electrode patterns of the common electrode 13 extend. From each of the electrode patterns of the sensor detection electrode 24, sensor signal Rx is output, and those sensor signals Rx are input to the sensor signal detector 250 shown in FIG. 1. In the present embodiment, in particular, sensor signals Rx which are output from electrode patterns 1 to m, respectively, are referred to as output signals Rx1 to Rxm. The sensor detection electrode 24 outputs m sensor signals Rx1 to Rxm which are obtained at the timing when sensor driving signal Tx1 is applied. Similarly, the sensor detection electrode 24 outputs m sensor signals Rx1 to Rxm which are obtained at the timing when sensor driving signal Tx2 is applied. Similarly after that, the sensor detection electrode 24 outputs m sensor signals Rx1 to Rxm which are obtained at the timing when sensor driving signal Txn is applied.

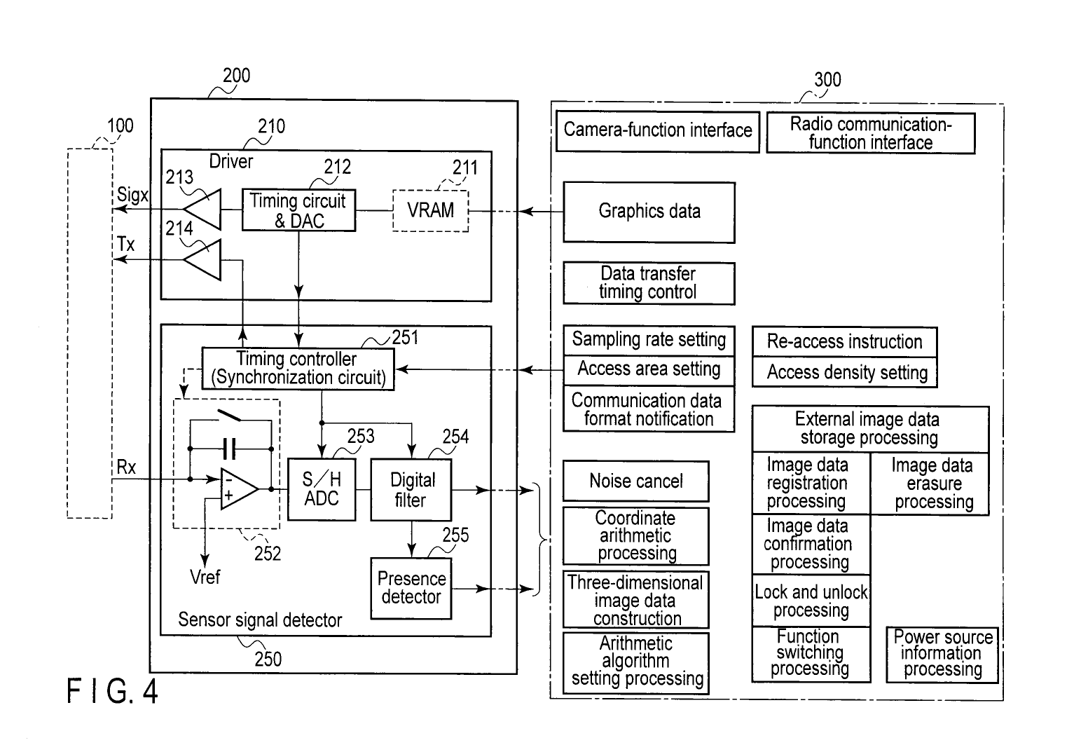

FIG. 4 is another view for illustrating the sensor-integrated display device 100, the data transfer device 200 and the application execution device 300.

Here, the figure further shows an example of the internal components of the data transfer device 200 and the application execution device 300.

The data transfer device 200 mainly includes the driver 210 and the sensor signal detector 250. The names of the driver 210 and the sensor signal detector 250 are not limited to these, and can be called an indicator driver IC and a touch IC, respectively. Though they are indicated as different elements in the block diagram, they can be formed integrally as one chip.

The driver 210 receives graphics data from the application execution device 300. The graphics data is time-divided and has a blanking period. The graphics data is input to a timing circuit and digital-to-analog converter 212 through a video random access memory (VRAM) 211 serving as a buffer. Note that the VRAM 211 may not be provided in the driver 210.

Display signal SigX indicative of an analog quantity is amplified by an output amplifier 213 and input to the sensor-integrated display device 100 to be written on a display element. A blanking signal detected by the timing circuit and digital-to-analog converter 212 is input to a timing controller 251 of the sensor signal detector 250. The timing controller 251 may be provided in the driver 210 and called a synchronization circuit.

The timing controller 251 generates driving signal Tx for driving the sensor during a given period of display signal SigX (which may be a blanking period, for example). The timing of driving signal Tx will be described later. Driving signal Tx is amplified by an output amplifier 214 and input to the sensor-integrated display device 100.

Driving signal Tx drives the sensor detection electrode to output sensor signal Rx from the sensor-integrated display device 100. Sensor signal Rx is input to an integrating circuit 252 in the sensor signal detector 250. Sensor signal Rx is integrated in the integrating circuit 252 and an integral signal is output. Then, sensor signal Rx is reset for each detection unit period by a switch, and an Rx analog signal can be obtained. The output from the integrating circuit 252 is input to a sample-hold and analog-to-digital converter 253 and digitized. The digitized detection data is input to the application execution device 300 through a digital filter 254 as raw data.

The detection data is three-dimensional data (data of a plurality of bits) including both the detected data and the non-detected data of an operation input. A presence detector 255 operates, for example, when the application execution device 300 is in a sleep mode and no coordinates of a touched position on the operation surface are detected. If there is any object close to the operation surface, the presence detector 255 can sense the object and turn off the sleep mode.

The application execution device 300 receives and analyzes the detection data, and can output the graphics data in accordance with a result of the analysis. Further, the application execution device 300 can switch the operating function of the system.

The application execution device 300 can deploy various applications to execute setting of an operating procedure of the device, switching of a function, generation and switching of display signal SigX, and the like. By using a sensor signal output from the sensor signal detector 250, the application execution device 300 can perform coordinate arithmetic processing and analyze an operating position. Since the sensor signal is captured as image data, three-dimensional image data can be constructed by an application. The application execution device 300 can also execute registration processing, erasure processing and confirmation processing, for example, for the three-dimensional image data. Furthermore, the application execution device 300 can lock or unlock the operating function by comparing the registered image data with the acquired image data.

When the sensor signal is acquired, the application execution device 300 can change the frequency of a driving signal output from the timing controller 251 to the sensor detection electrode and control the output timing of the driving signal. Accordingly, the application execution device 300 can switch a drive area of the sensor component 150 and set a driving speed of the same.

The application execution device 300 can also detect the density of the sensor signal and add additional data to the sensor signal.

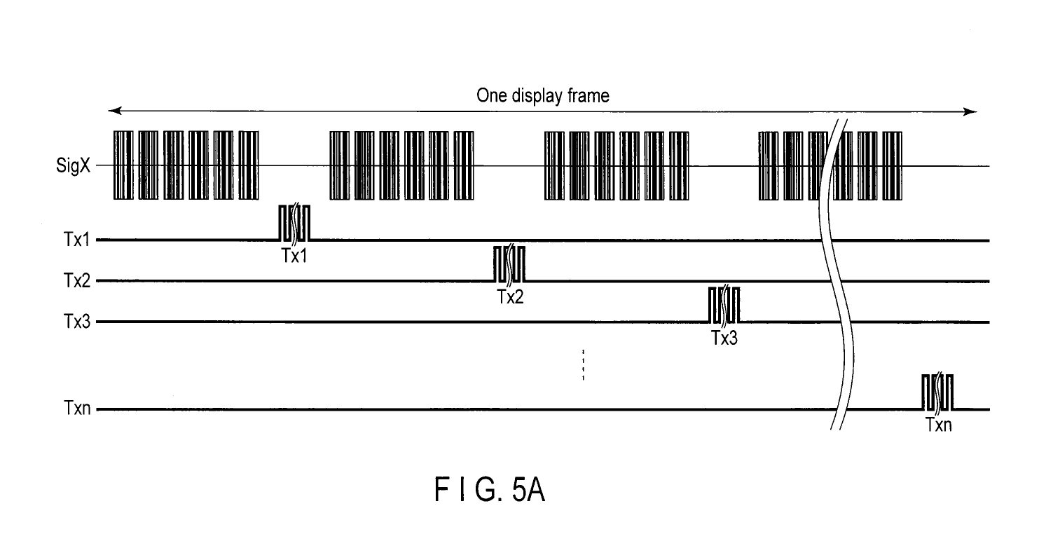

FIG. 5A shows an example of a timing chart between display signal SigX and sensor driving signals Tx (Tx1-Txn) which are input to the sensor-integrated display device 100 in one display frame. FIG. 5B schematically shows the state of a two-dimensionally scan performed by common voltage Vcom and sensor driving signals Tx in the sensor component 150 including the common electrode 13 and the sensor detection electrode 24. Common voltage Vcom is applied to the common electrode 13 in order. Further, driving signals Tx for obtaining a sensor signal in a given period are applied to the common electrode 13.

The data transfer device 200 inputs display signal SigX in one display frame to the sensor-integrated display device 100 in a time-divided manner. The data transfer device 200 inputs sensor driving signals Tx1-Txn to the sensor-integrated display device 100 so that they are inserted into the blanking periods of the time-divided display signal SigX, respectively.

Timing between display signal SigX and sensor driving signals Tx1-Txn as shown in FIG. 5A is set by the application execution device 300. That is, the application execution device (transmitter) 300 time-divides the graphics data which becomes a source of display signal SigX, and transmits the time-divided data to the data transfer device 200 sequentially, so that display signal SigX is input to the sensor-integrated display device 100 in a time-divided manner as shown in FIG. 5A. The data transfer device 200 converts the time-divided graphics data into display signal SigX every time the time-divided graphics data is received, and supplies the converted display signal SigX to the sensor-integrated display device 100. The application execution device (transmitter) 300 transmits the timing information for inputting sensor driving signals Tx1-Txn to the sensor-integrated display device 100 in the blanking periods of the time-divided display signal SigX, as shown in FIG. 5A, to the data transfer device 200. Note that the application execution device 300 can arbitrarily determine in which period of the blanking periods of the time-divided display signal SigX sensor driving signals Tx1-Txn should be inserted. The data transfer device 200 inputs each of sensor driving signals Tx1-Txn to the sensor-integrated display device 100 based on the timing information. Note that sensor driving signal Tx is supplied to the common electrode 13 already described via the timing controller 251 and the amplifier 214. Timing at which sensor driving signal Tx is output from the timing controller 251, a frequency of sensor driving signal Tx, and the like can be changed arbitrarily by the instruction of the application execution device 300. Further, the timing controller 251 can supply a reset timing signal to the integrating circuit 252 of the sensor signal detector 250, and a clock to the sample-hold and analog-to-digital converter 253 and the digital filter 254. The integrating circuit 252 may be omitted, and sensor signal Rx from the sensor-integrated display device 100 may be input to the sample-hold and analog-to-digital converter 253 and the digital filter 254.

The application execution device 300 may arbitrarily change the timing at which the graphics data is time-divided in one display frame, the number of time-divisions, the timing at which sensor driving signals Tx1-Txn are supplied to the sensor-integrated display device 100, and the like, according to the application or the operation mode set by the user (for example, whether emphasis should be placed on detection accuracy, graphic display, low power consumption, etc.). The application execution device 300 may be set to apply sensor driving signals Tx1-Txn to the common electrode 13 for a plurality of times in one display frame. For example, in one display frame, after sensor driving signals Tx have been applied to the common electrode 13 in the order of sensor driving signals Tx1-Txn, they may be applied to the common electrode 13 again in the order of sensor driving signals Tx1-Txn. When sensor driving signals Tx1-Txn are applied to the common electrode 13 for a plurality of times in the display frame, the number of detecting signals in one display frame can be increased (i.e., detection performance can be enhanced). Although FIG. 5A shows an example in which one set of sensor driving signals Tx are applied to the common electrode 13 in the blanking periods of the time-divided display signal SigX, the embodiment is not limited to this.

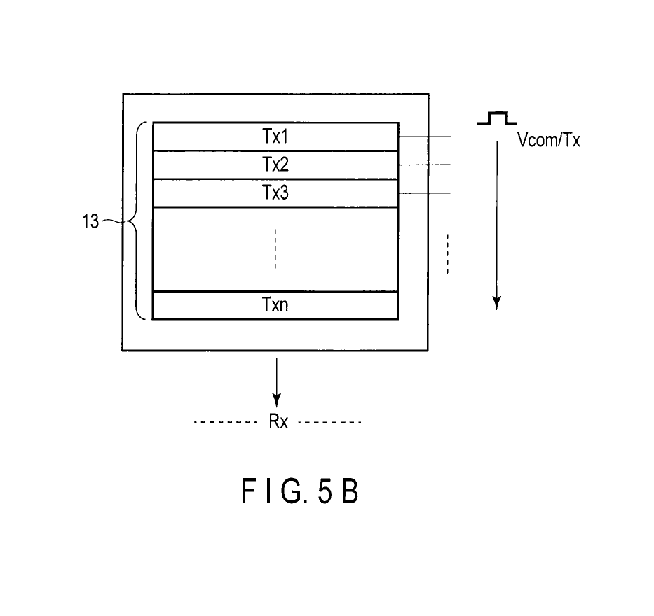

FIG. 6 shows another embodiment. A mobile terminal 1 includes an application execution device 300. In an embodiment described above, the application execution device 300 outputs graphics data to a first bus connected to a data transfer device 200, and receives sensor signal data through a second bus connected to the data transfer device 200. Alternatively, the application execution device 300 may be structured such that the graphics data is output to a bus connected to the data transfer device 200, and the sensor signal data is received by a receiver through the same bus. FIG. 6 shows an example in which a single bus is used for receiving the sensor signal data and transmitting the graphics data. For example, the application execution device 300 may be structured such that the sensor signal data is received in the blanking periods of the time-divided graphics data (display signal SigX corresponding to it). If the bus can be shared, the structure of the system can be expected to be simplified. Since the other structures of the mobile terminal 1 shown in FIG. 6 are the same as the structures shown in FIGS. 1 and 4, explanations thereof are omitted.

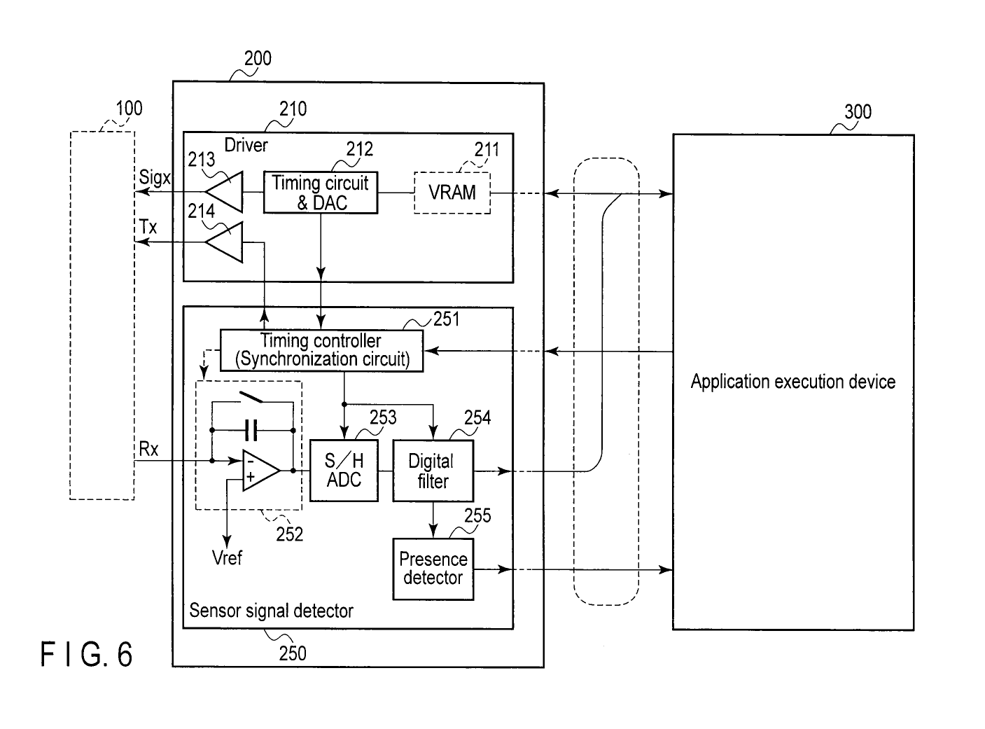

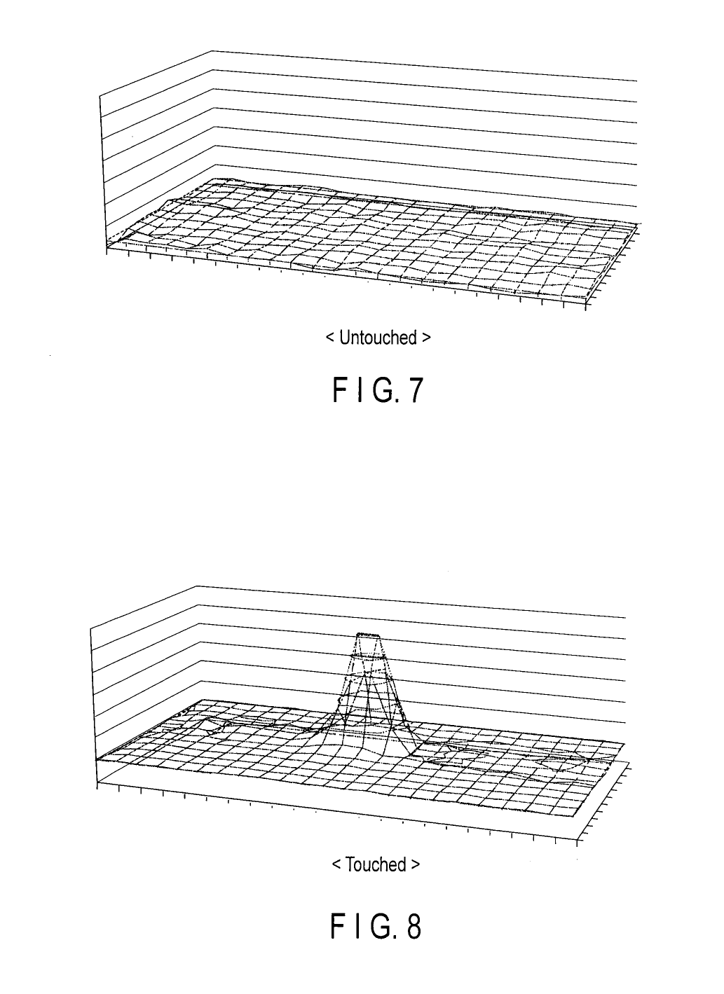

FIG. 7 is a 3D graph showing an example of raw data on a sensor signal when no operation input is detected. FIG. 8 is a 3D graph showing an example of raw data on a sensor signal when an operation input is detected. The raw data shown in FIGS. 7 and 8 is based on sensor signals Rx1-Rxm obtained by sensor driving signals Tx1-Txn described above, respectively.

According to the present embodiment, the application execution device 300 sets timing between display signal SigX and sensor driving signals Tx, thereby directly controlling the timing between display signal SigX and sensor driving signals Tx for the data transfer device 200. Thus, the data transfer device 200 should apply display signal SigX converted from the time-divided graphics data to the sensor-integrated display device 100 every time the time-divided graphics data is received, and apply sensor driving signals Tx to the sensor-integrated display device 100 based on the timing information on the sensor driving signals Tx. Accordingly, the load of processing of the data transfer device 200 can be relieved. Further, since the data transfer device 200 immediately converts the time-divided graphics data into display signal SigX and applies the converted display signal SigX to the sensor-integrated display device 100, a bulk memory, such as the video random access memory 211, for storing the graphics data is not required. Furthermore, according to the present embodiment, by selecting a cyclic frequency at which the sensor driving signals are supplied to the drive (common) electrode as appropriate, interference is not caused in the mobile terminal 1. As described above, according to the present embodiment, there is no need to control the detection timing of a touch by the data transfer device 200, and so the reliability of the timing control can be increased as well as cutting down on cost.

The names of the blocks and components are not limited to those described above, nor are the units thereof. The blocks and components can be shown in a combined manner or in smaller units. The term “unit” may be replaced by terms such as “device”, “section”, “block”, and “module”. Even if the terms are changed, they naturally fall within the scope of the present disclosure. Further, structural elements in the claims that are expressed in a different way, such as in a divided manner or in a combined manner, still fall within the scope of the present disclosure. Furthermore, the method claims, if any, are based on the device of the present embodiment.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

In the present embodiment, while the structure of the application processor 300 may be realized by hardware, it may also be realized by software.

In the above, the structure in which the sensor-equipped display device comprises a liquid crystal display device as the display device has been described. However, the structure may be one including other display devices such as an organic electroluminescent display device. The example shown in FIG. 2A, etc., illustrates the structure of a liquid crystal display device in which both the pixel electrode and the common electrode are provided on the array substrate, namely, the structure in which a lateral electric field (including fringe field), for example, an In-plane Switching (IPS) mode or a Fringe Field Switching (FFS) mode, is mainly used. However, the structure of the liquid crystal display device is not limited to the above. It is also possible to arrange at least the pixel electrode to be provided on the array substrate, and the common electrode to be provided on either the array substrate or the counter-substrate. In the case of mainly using a vertical electric field, for example, a Twisted Nematic (TN) mode, an Optically Compensated Bend (OCB) mode, or a Vertically Aligned (VA) mode, the common electrode is provided on the counter-substrate. That is, the position where the common electrode is arranged may be any place as long as it is positioned between the insulting substrate which constitutes the TFT substrate and the insulating substrate which constitutes the counter-substrate.

In the above, it has been described that the sensor signal can be obtained when the finger touches the touchpanel. However the meaning of “touch” in the embodiments includes a meaning such as making an approach or getting close to the touchpanel.

What is claimed is:

1. An electronic device comprising:
a sensor-integrated display panel configured to integrally comprise an operation surface for giving an operation input to a sensor and a display surface of an image;
a data transfer device configured to input a display signal and a driving signal for the sensor to the sensor-integrated display panel and to receive a sensor signal from the sensor; and
an application execution device configured to time-divide display data which becomes a source of the display signal to transmit it to the data transfer device, and to transmit, to the data transfer device, timing information for inputting the driving signal to the sensor-integrated display panel in a blanking period of the time-divided display data.

2. The electronic device according to claim 1, wherein the application execution device outputs the display data to a bus connecting to the data transfer device, and receives data based on the sensor signal in the blanking period of the display signal through the bus.

3. An application execution device controlling a display module including a sensor-integrated display panel and a data transfer device,
the sensor-integrated display panel comprising an operation surface for giving an operation input to a sensor and a display surface of an image,
the data transfer device configured to input a display signal based on display data and a driving signal for the sensor to the sensor-integrated display panel and to receive a sensor signal from the sensor,
the application execution device comprising:
a transmitter configured to transmit timing information to the data transfer device, wherein the data transfer device time-shares display data and the driving signal, the driving signal is in a blanking period of the time-divided display data according to the timing information; and
a receiver configured to receive data on the sensor signal from the data transfer device.

4. A method for controlling an electronic device comprising a sensor-integrated display panel integrally comprising an operation surface for giving an operation input to a sensor and a display surface of an image, and a data transfer device configured to input a display signal and a driving signal for the sensor to the sensor-integrated display panel and to receive a sensor signal from the sensor,
the method comprising:
transmitting data obtained by time-dividing display data which becomes a source of the display signal, to the data transfer device; and
transmitting, to the data transfer device, timing information for inputting the driving signal to the sensor-integrated display panel in a blanking period of the time-divided display data.
